(19) United States
(12) Patent Application Publication
(10) Pub. No.: US 2011/0005088 A1
(43) Pub. Date: Jan. 13, 2011

(54) PORTABLE ELECTRIC CHAINSAW

(75) Inventor: Roger Pellenc, Pertuis (FR)

Correspondence Address: EGBERT LAW OFFICES, 412 MAIN STREET, 7TH FLOOR, HOUSTON, TX, 77002, US

(73) Assignee: PELLENC (SOCIETE ANONYME), Pertuis (FR)

(21) Appl. No.: 12/808,935

(22) PCT Filed: Dec. 17, 2008
(86) PCT No.: PCT/FR2008/001762

§ 371 Date: Sep. 9, 2010

(30) Foreign Application Priority Data
Dec. 20, 2007 (FR) 0708941

(51) Int. Cl. B27B 17/08; B27B 17/12; B27B 17/02

(52) U.S. Cl. 30/383; 30/515

(57) ABSTRACT

A motor-driven portable chainsaw of the sort that includes a power source enclosed in a casing and a cutter device comprising a toothed chain and a chain guide. The saw being characterized in that the power source is a brushless direct-current electric motor controlled and switched electronically, with a rotor with magnets. A handle for holding and operating the saw is located underneath the motor assembly which supports the chain guide and includes said direct-current electric motor.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a portable electric chainsaw.

2. Description of Related Art Including Information Disclosed Under 37 CFR 1.97 and 37 CFR 1.98

Portable chainsaws are generally used for cutting off branches or for forest work such as felling, trimming and slashing of trees.

These saws are motorized tools configured for cutting wood and consist essentially of an integrated compact device including a power source, a cutting system and handles positioned and adapted to being grasped and held with both hands when in operation.

Most often the power source consists of a combustion engine which implies a relatively noisy and polluting operation.

One is also familiar with portable chainsaws the power source of which consists of an electric DC or AC brush motor with a power between 400 and 2500 Watt and quieter and non-polluting operation.

However, whatever the nature (combustion or electric) of their power source, the presently available chainsaws must be held and maneuvered with both hands for the performance of delimbing or forest work, especially because of their weight (between 3.6 kg and 6.2 kg depending on the models, empty, without chain or guide bar, and without electric power cable for the chainsaws with electric motors, and in the order of 3.5 kg to 9.9 kg, depending on the models, with an empty tank, without guide bar and without chain for chainsaws with a combustion engine. One understands that this relatively heavy weight can be a considerable fatigue factor for the users that need to use such tools frequently and for prolonged periods of time.

On the other hand, chainsaws with direct-current brush motors are clearly underpowered to permit their utilization in an intensive manner or for professional purposes.

Whether they are equipped with a combustion engine or an electric motor, chainsaws are provided with two carrying handles, and also because of the requirements (more or less considerable weight of the tools) as well as the habits of the workers, one of these handles, usually called the “front handle” is positioned above the motor block of the tool and the other one generally called the “rear handle”, behind said motor block or to the side of it (when the handle consists of a counter-handle linked to the front handle) looking at the position of the tool when vertical cuts are made. The particular inconvenience of this situation is that both hands are permanently occupied and the workability of these tools is restricted.

The document U.S. Pat. No. 5,685,080 describes a chainsaw featuring a single handle located in a direction essentially parallel to the guide bar and, more specifically, to the rear and in the extension of the motor and guide bar assembly, looking at the position of the saw while making a vertical cut into the wood.

The handling of such a motorized apparatus is inconvenient and tiring, especially on account of the position of the handle and the location of the center of gravity of said apparatus forward and away from the user's hand.

The aim of the present invention is specifically a portable electric chainsaw that would remedy the aforementioned disadvantages.

### BRIEF SUMMARY OF THE INVENTION

According to the invention, this objective has been achieved owing to a portable electric chainsaw, with a brushless direct current motor with magnetic rotors with electronic controls and switches, and a holding handle located below the motor assembly including said direct-current electric motor, looking at the position of the saw during a vertical cut. In other words, the holding handle is oriented perpendicularly or approximately perpendicularly to the longitudinal axis of the guide bar, so that the saw can be held by a single hand.

Advantageously, the holding handle is located below the drive sprocket gearing with the cutting chain.

It is possible to produce and use electric motors of the aforementioned type developing up to 2500 Watts and a weight below 0.5 kg so that it is possible to manufacture extremely lightweight tools, for example with a weight (all components included) in the order of 1.9 kg. The invention makes it thus possible to reduce the stress involved in sawing work performed with a portable chainsaw.

It improves considerably the workability of this type of tool which, although being very powerful, can be held with one hand, like a keyhole saw, by freeing the other hand of the user, this possibility being very advantageous, for instance for pruning fruit trees.

According to a preferred mode of execution, the trigger or on-off switch (and the safety trigger when the tool is equipped with a safety trigger), controlling the start and stop of the power source, is (are) accessible on the handle of the chainsaw.

According to an advantageous mode of execution, the pump for circulating the lubrication fluid is housed in the tool handle, preferably in its lower portion.

### BRIEF DESCRIPTION OF THE DRAWINGS

The above aims, characteristics and advantages and still more, will become clearer from the following description and the attached drawing in which:

FIG. 1 is a schematic view of a traditional portable chainsaw.

FIG. 2 is a side view (left side) with a cut-away, of a production example of a portable chainsaw according to the invention.

FIG. 3 is a side view (right side) of this chainsaw.

FIG. 4 is a side view (right side) with cut-aways, and at a larger scale, of this chainsaw shown without the toothed chain and with the guide bar shown partially.

FIG. 5 is a perspective view of the chainsaw connected to a portable independent battery, according to an advantageous mode of execution of the invention.

Reference is made to said drawings to describe an interesting, although by no means limiting, example of production of the portable electric chainsaw according to the invention.

### DETAILED DESCRIPTION OF THE INVENTION

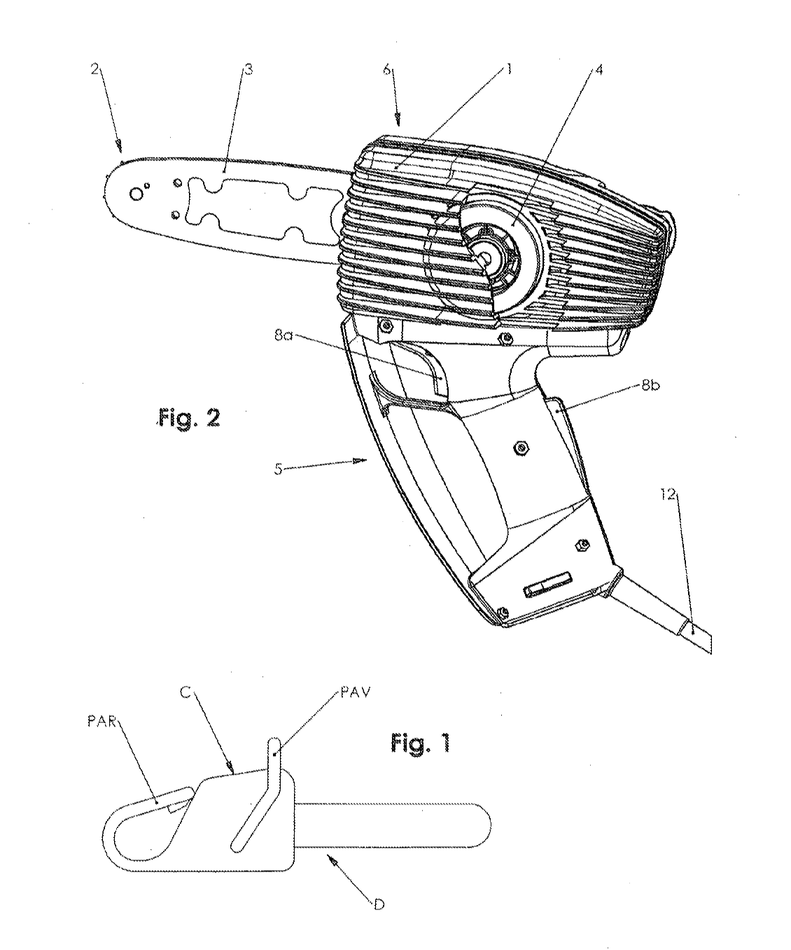

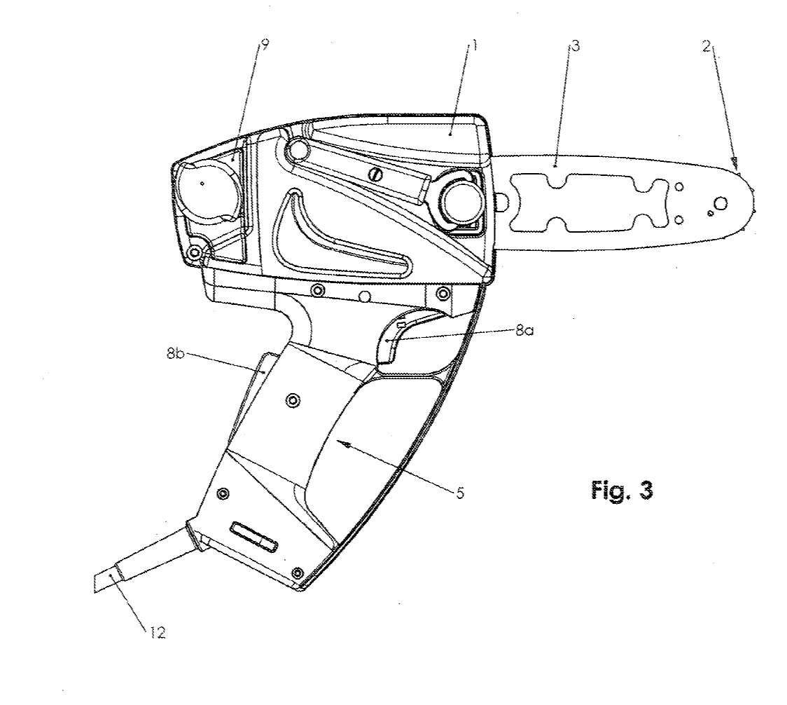

FIG. 1 shows a portable chainsaw with a motorized drive of a current model including a compact integrated device including a power source (thermal engine or AC electric motor) enclosed in a housing C, a cutting device D including a toothed chain and a guide bar, and two carrying handles, namely one front handle (PAV) and a rear handle (PAR), configured so as to allow holding and manipulating the tool with both hands.

The portable chainsaw with a motorized drive according to the invention includes, as usual, a power source that is enclosed in a housing 1 and a cutting device including a toothed chain 2 geared with a drive sprocket 7 and a guide bar 3 supporting and holding said chain.

According to the invention, the power source ensuring the rotation of the drive sprocket 7 includes a direct-current electric motor 4, with a rotor with magnets, of the brushless type and with electronic controls and switches. A holding and manipulating handle 5 is located below the motor assembly including said direct-current electric motor 4, said handle 5 being oriented perpendicularly or essentially perpendicularly to the longitudinal axis of the guide bar 3.

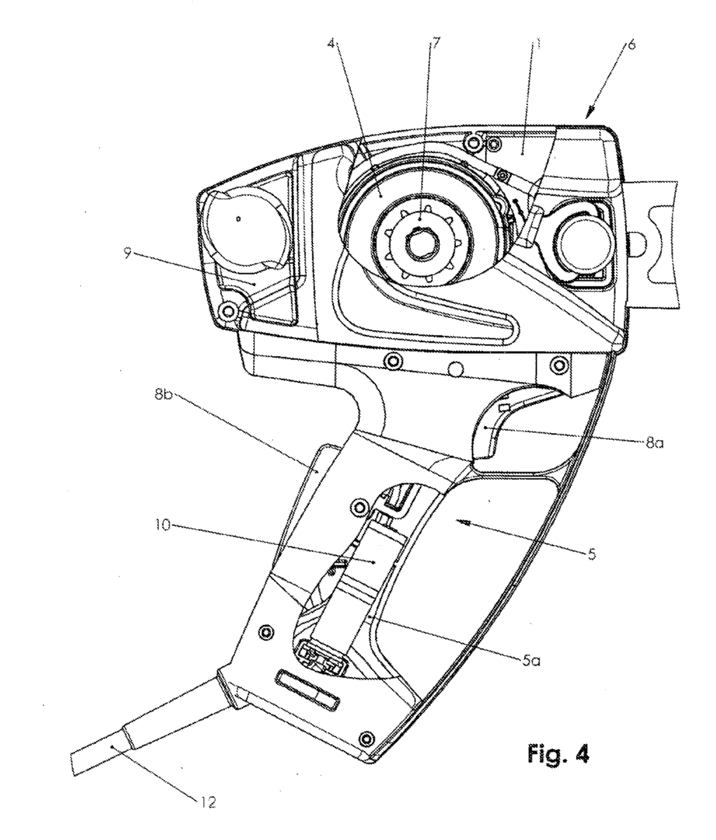

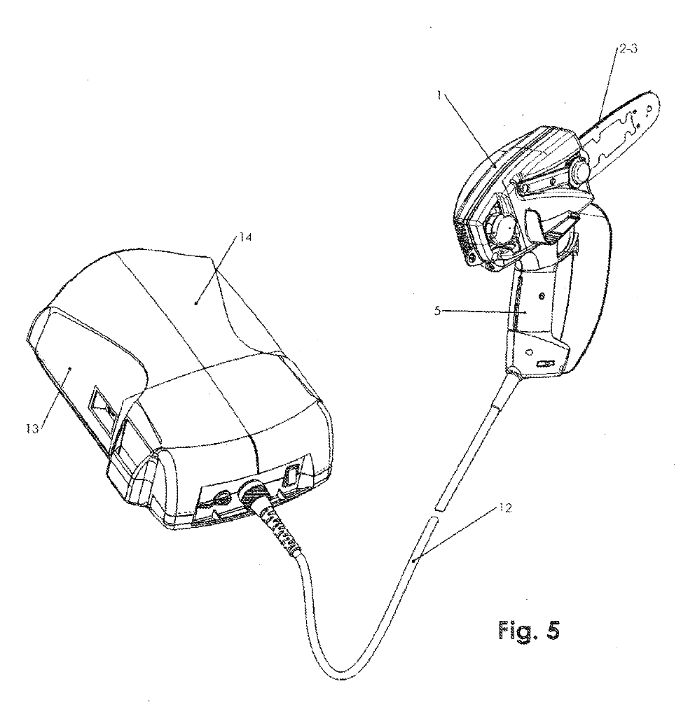

More specifically and advantageously, the holding handle 5 is located below the drive sprocket 7 gearing with the toothed chain 2 (FIG. 4).

According to an interesting mode of execution, the drive sprocket 7 is mounted coaxially to the axis of the rotor of the motor 4.

The direct-current electric motor 4 may be capable of supplying a power between 600 and 2500 effective Watt.

It may present a weight of less than 0.5 kg and, for example, a weight of less than 0.4 kg. According to an example of application, the motor 4 may present a weight of 0.3 kg and provide a power of 1200 Watt, the tool having an all-inclusive weight of 1.880 kg.

The trigger or on-off switch 8A of the tool is accessible on handle 5 and in front of it. It is, for example, mounted with a pivoting capability, to the upper part of handle 5.

On the other hand, as is most often the case and as required by prevalent regulations, when the chainsaw is equipped with a safety trigger 8B, this trigger is also mounted on the handle 5, and, preferably at the rear of the latter.

Portable chainsaws also include a lubrication system for moving parts of the tool, housed in the motor housing. This system includes a reservoir for the lubrication fluid, generally being oil, and a distributing pump driven by an electric motor.

According to a preferred mode of execution of the invention, the reservoir 9 holding the lubrication fluid may be advantageously positioned in the housing 1, behind the electric motor 4.

On the other hand, the pump 10 providing the distribution of the lubrication fluid in the reservoir 9, may be advantageously housed in the handle 5, below said reservoir 9, preferably in the lower part 5a of said handle. Owing to this location, the electric distributing pump 10 is being constantly self-primed.

The control and management of the operation of the direct-current electric motor and/or of the lubrication pump 10 are provided by an electronic board.

According to one mode of execution, this electronic piloting board is integrated into the holding and manipulating handle 5 of the saw.

An electric supply cord 12 connected to the tool, preferably to the lower part of the handle 5, provides the connection of the motorization of the portable chainsaw, to a source of direct current. The source may include an independent rechargeable portable battery 13, housed in a backpack 14 or in a belt worn by the user.

According to another mode of execution, the electronic board for control or piloting is integrated in the battery 13.

1. Portable chainsaw with a motorized drive of the type which includes a power source enclosed in housing and a cutting device comprising a toothed chain gearing with a drive sprocket, and a guide bar, characterized in that:
the power source for the rotation of the drive sprocket includes a brushless direct-current motor controlled and switched electronically, with a rotor with magnets, and
a holding and manipulating handle which is located below said drive sprocket, while looking at the position of the saw during a vertical cutting action through wood during which the guide bar and the chain are in an essentially horizontal position.

2. Portable electric chainsaw according to claim 1, characterized in that the drive sprocket is mounted coaxially to the axis of the rotor of the motor and in that the holding handle is located below the motor assembly comprising said motor and said drive sprocket.

3. Portable electric chainsaw according to claim 1, further comprising a lubrication system for the mobile elements of the tool, comprising a reservoir and a distributing pump characterized in that the reservoir containing the lubrication fluid is placed in the housing behind the motor.

4. Portable electric chainsaw according to claim 1, further comprising a lubrication system of the mobile elements of the tool, comprising a reservoir and an electric distributing pump, characterized in that said pump is housed in the handle (5) of the tool, below said reservoir.

5. Portable electric chainsaw according to claim 4, characterized in that the electric distributing pump is housed in the lower part of the handle.

6. Portable electric chainsaw according to claim 1, including a trigger or on-off switch of the tool, characterized in that this trigger is accessible on the handle of said tool, and in front of the handle.

7. Portable electric chainsaw according to claim 1, featuring a safety trigger, characterized in that said safety trigger is accessible on the handle of the tool, and behind the handle.

8. Portable electric chainsaw according to claim 1, characterized in that it features an electronic board for the control, switching, and management of operation of the direct-current electric motor and/or the control and management of the distributing pump.

9. Portable electric chainsaw according to claim 1, characterized in that it comprises a portable rechargeable independent battery and in that the electric power cable attached to the tool permits the connection of said tool to said battery.

10. Portable electric chainsaw according to claim 8, characterized in that the electronic board is integrated into the handle of said saw.

11. Portable electric chainsaw according to claim 8, characterized in that the electronic board is integrated into the battery.
